(19) United States
(12) Patent Application Publication
(10) Pub. No.: US 2008/0157502 A1
(43) Pub. Date: Jul. 3, 2008

(54) FOLDABLE BICYCLE HAVING X-SHAPED FRAME

(76) Inventor: Kuang-Huan Fu, Yilan Hsien (TW)

Correspondence Address: LEONG C LEI, PMB # 1008, 1867 YGNACIO VALLEY ROAD, WALNUT CREEK, CA, 94598, US

(21) Appl. No.: 11/617,752

(22) Filed: Dec. 29, 2006

(51) Int. Cl. B62K 3/02

(52) U.S. Cl. 280/278

(57) ABSTRACT

A foldable bicycle has an X-shaped frame including a folding device having two hinged portions to which two connection bars and a seat bar and a rear fork are fixed respectively to form an X-shape in an expanded condition. The two portions can be opened to fold the X-shaped frame. A handlebar and a front fork are respectively coupled to the connection bars. A shock absorbing device includes upper and lower tubes connected to the handlebar and the front fork respectively with a spring arranged therebetween. An adjusting device is arranged adjacent to a rear wheel to carry an auxiliary wheel through a bracket. The adjusting device allows the bracket to be positioned at an operation condition, a backward-bent standby condition, and a forward-bent stowed condition.

### BACKGROUND OF THE INVENTION

(a) Technical Field of the Invention

The present invention relates to a foldable bicycle, and in particular to a foldable bicycle having an X-shaped frame, which provides comfortable riding in an expanded condition and easy stowage and transportation in a folded condition.

(b) Description of the Prior Art

Bicycles have been well known and widely used for leisure activities and easy and convenient transportation. The progress of bicycle technology makes modern bicycle light in weight and effortless in riding. In addition thereto, ease of stowage and transportation and comfortableness of riding are also concerns for the modern bicycles. Although some of the modern bicycles available in the market are of a foldable configuration for easy storage and shipping and some are equipped with shock absorber for making bicycle riding more comfortable for riders, the folding structure of the modern foldable bicycles or the known bicycle shock absorbers are complicated in construction. This not only increases costs but also makes manufacturing difficult.

Thus, it is desired to have a foldable bicycle that overcomes the above discussed problems of the conventional bicycles.

### SUMMARY OF THE INVENTION

The primary purpose of the present invention is to provide a foldable bicycle having an X-shaped frame to provide comfortable riding and easy and convenient stowage and transportation.

The foldable bicycle of the present invention comprises a handlebar and a front fork between which a shock absorbing device comprising upper and lower tubes connected to the handlebar and the front fork respectively and a spring arranged between the upper and lower tubes is provided for damping the shocks and vibrations induced during the riding of the bicycle so as to make riding of the bicycle comfortable.

The foldable bicycle of the present invention comprises a folding device comprising a body constituted by two portions hinged to each other and respectively carrying connection bars mounted to the handlebar and the front fork and a seat bar and a rear fork. The two portions of the body can be moved between a closed condition where the seat bar and the rear fork are opposite to the connection bars with respect to the body so as to effect expansion of the bicycle frame in an expanded condition and an open condition where the connection bars and the seat bar and the rear fork are brought toward each other to effect a folded condition of the bicycle.

The bicycle of the present invention comprises an adjusting device arranged at a location corresponding to a rear wheel and carrying an auxiliary wheel. The adjusting device allows the auxiliary wheel to be positioned in an operation condition where the auxiliary wheel is substantially parallel to the rear wheel to provide additional support to the bicycle, a non-operation standby position where the auxiliary wheel is moved backward or a stowed position where the auxiliary wheel is moved forward to reduce the amount of space for stowing.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of a foldable bicycle constructed in accordance with the present invention;

FIG. 2 is an exploded view of a shock absorbing device of the foldable bicycle of the present invention;

FIG. 3 is a cross-sectional view of the shock absorbing device of the present invention;

FIG. 4 is an exploded view of a folding device of the foldable bicycle of the present invention;

FIG. 5 is a perspective view of the folding device of the present invention in a closed condition where the bicycle is in an expanded condition;

FIG. 6 is a perspective view of the folding device of the present invention in an opened condition where the bicycle is in a folded condition;

FIG. 7 is an exploded view of an adjusting device of the foldable bicycle of the present invention;

FIG. 8 is a cross-sectional view of the adjusting device of the present invention;

FIG. 9 is a perspective view of the foldable bicycle of the present invention illustrating a non-operation standby condition of auxiliary wheels of the bicycle; and

FIG. 10 is a perspective view of the foldable bicycle of the present invention illustrating a stowed condition of the auxiliary wheels of the bicycle.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

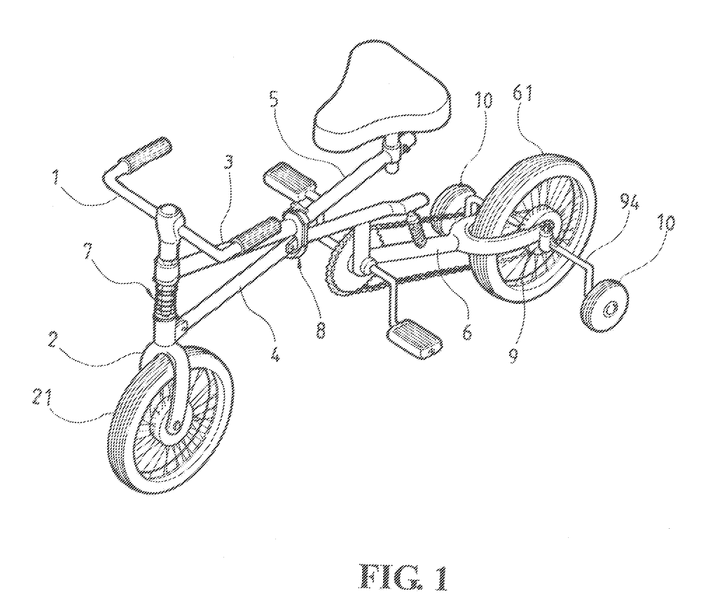

With reference to the drawings and in particular to FIG. 1, a foldable bicycle constructed in accordance with the present invention comprises a handlebar 1, a front fork 2, a front wheel 21, connection bars 3, 4, a seat bar 5, a rear fork 6, and a rear wheel 61. A shock absorbing device 7 is arranged between the handlebar 1 and the front fork 2 to make riding of the bicycle comfortable. A folding device 8 is arranged at a central position of the bicycle to connect the connection bars 3, 4 that carry the handlebar 1 and the front fork 2 respectively and the seat bar 5 and the rear fork 6. The folding device 8 functions to switch the bicycle between an expanded riding condition and a symmetrical folded condition. On opposite sides of the rear wheel 61, two adjusting devices 9 are arranged at locations corresponding to a center of the rear wheel 61 for coupling two auxiliary wheels 10. The adjusting devices 9 allow the auxiliary wheels 10 to be switched among an operation condition where the auxiliary wheels 10 are substantially parallel to each other, a non-operation standby condition where the auxiliary wheels 10 are folded backward and positioned close to each other, and a stowed condition where the auxiliary wheels 10 are folded forward and positioned close to the bicycle frame so as to reduce the amount of space that the bicycle occupies and thus facilitating storage.

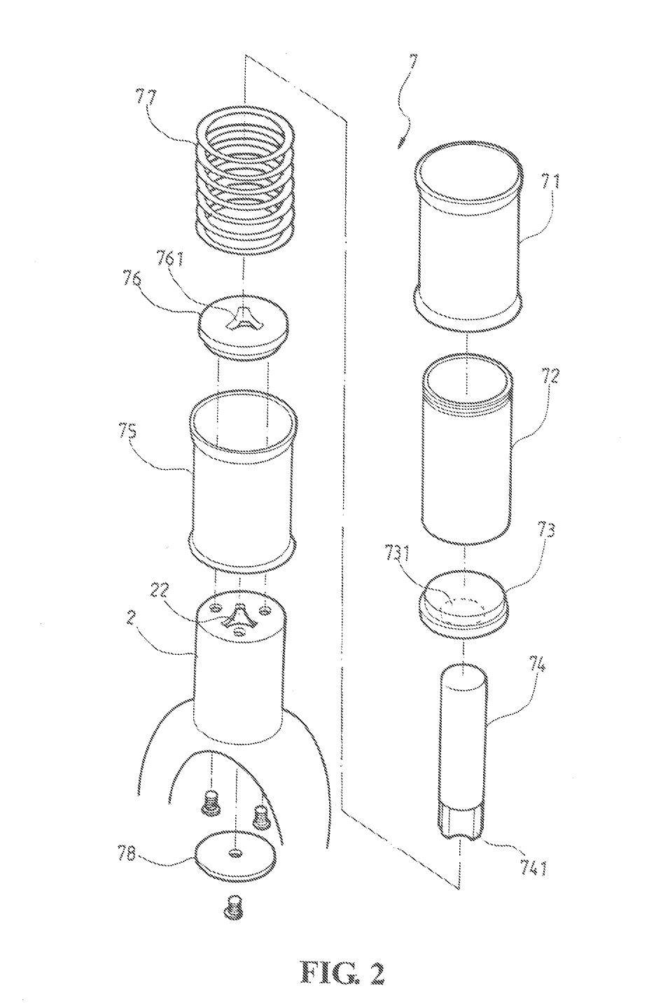

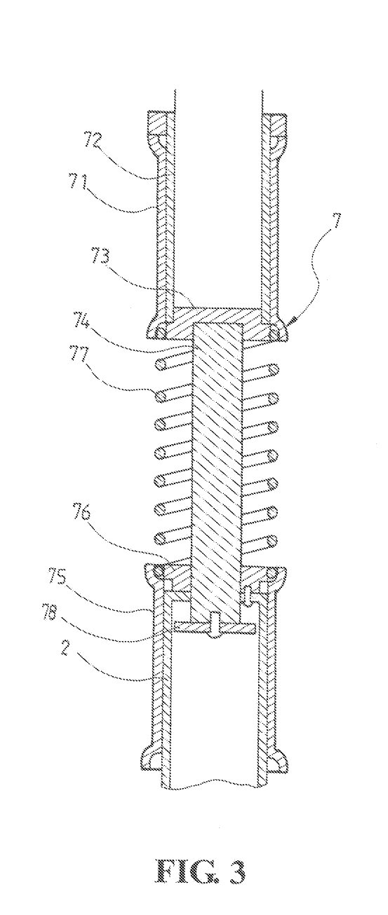

Also referring to FIGS. 2 and 3, the shock absorbing device 7 of the present invention comprises an upper tube 71 in which an inner tube 72 is fit to connect the handlebar 1. A block 73 is fit into and fixed to a lower open end of the inner tube 72. A mounting hole 731 is defined in the block 73 to fit over and fix to a positioning bar 74. The positioning bar 74 has a lower end forming a sliding section 741 having a substantially triangular cross section. A lower tube 75 receives a tubular portion of the front fork 2 therein and a block 76 is fit in the lower tube 75 and is securely fixed to a top end of the tubular portion of the front fork 2. The block 76 and the top end of the tubular portion of the front fork 2 are both formed with a substantially triangular opening 761, 22 complementary in shape to the sliding section 741 of the positioning bar 74. A spring 77 is fit over and encompasses the positioning bar 74 and is retained between the blocks 73, 76. A lower end of the spring 77 is secured to the block 76 of the lower tube 75. A retention disk 78 is secured to the lower end of the positioning bar 74 and located inside the tubular portion of the front fork 2 to prevent the positioning bar 74 from separating from the lower tube 75 and the front fork 2. Thus, when the bicycle is being ridden, the resiliency of the spring 77 effect cushioning and shock absorption. When the spring 77 is compressed and extended, the sliding section 741 of the positioning bar 74 slides upward and downward through the triangular openings 761, 22 of the block 76 and the front fork 2.

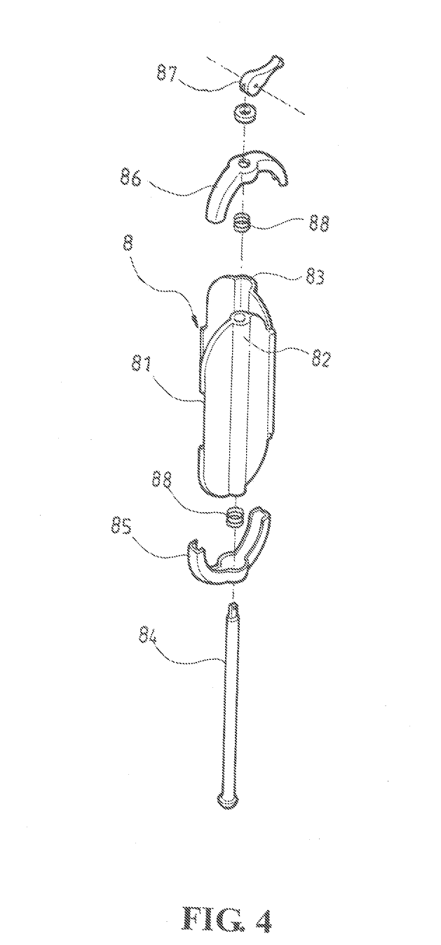

Referring to FIGS. 4 and 5, the folding device 8 of the present invention comprises a case-like body 81 having two portions that are hinged together so as to be openable and closeable with respect to each other. The connection bars 3, 4 are fixed to a first one of the portions of the body 81 and the seat bar 5 an the rear fork 6 are fixed to a second one of the portions of the body 81. One of the portions of the body 81 forms a vertically extending tube 82 at a middle thereof and the other one of the portions of the body 81 forms a complementary semi-circular groove 83 so that the tube 82 is partially accommodated in the groove 83 when the two portions of the body 81 are closed. Two U-shaped caps 85 and 86 are arranged at top side and bottom side of the body 81 and each forms a channel having a size and shape for partially fit over the top and bottom edges of the body 81 to retain the two portions of the body 81 in the closed position. A lock pin 84 has an upper end extending through a hole defined in the lower cap 85, the tube 82, and a corresponding hole defined in the upper cap 86 and pivotally coupled to a holding lever 87. A spring 88 is fit over the lock pin 81 and arranged between each of the caps 85, 86 and the tube 82. Thus, when the body 81 is closed and the caps 85, 86 are fit over the top and bottom edges of the closed body 81, depressing the holding lever 87 down to a locking position drives the lock pin 81 to tightly hold the caps 85, 86 against the body 81, as shown in FIG. 5, so as to maintain the bicycle in an expanded, riding condition.

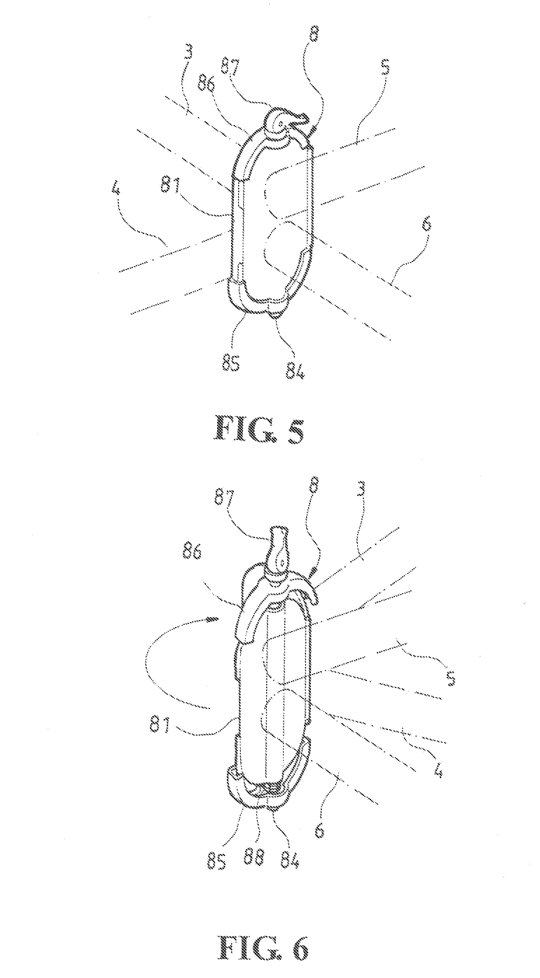

As shown in FIG. 6, when the holding lever 87 is moved upward, the springs 88 forces the caps 85, 86 to disengage from the body 81, whereby the two portions of the body 81 are opened and rotatable away from each other to bring the connection bars 3, 4 toward the seat bar 5 and the rear fork 6 so as to fold the bicycle for storage and transportation.

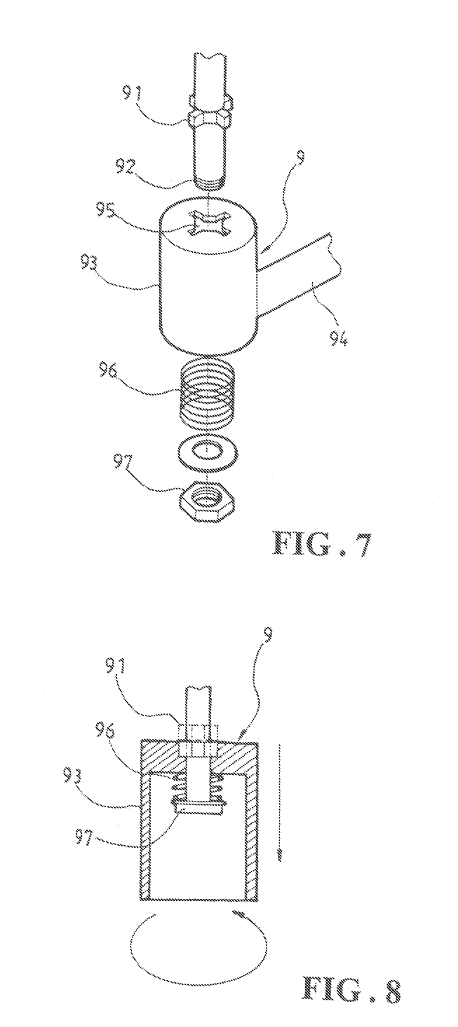

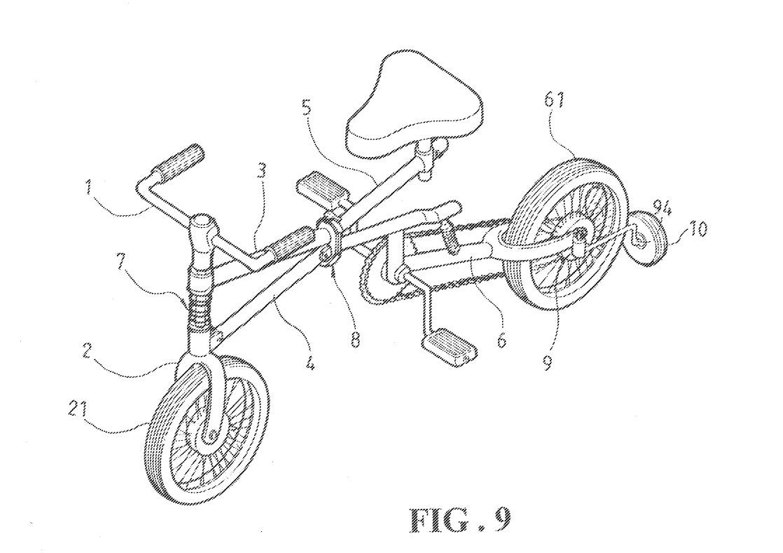

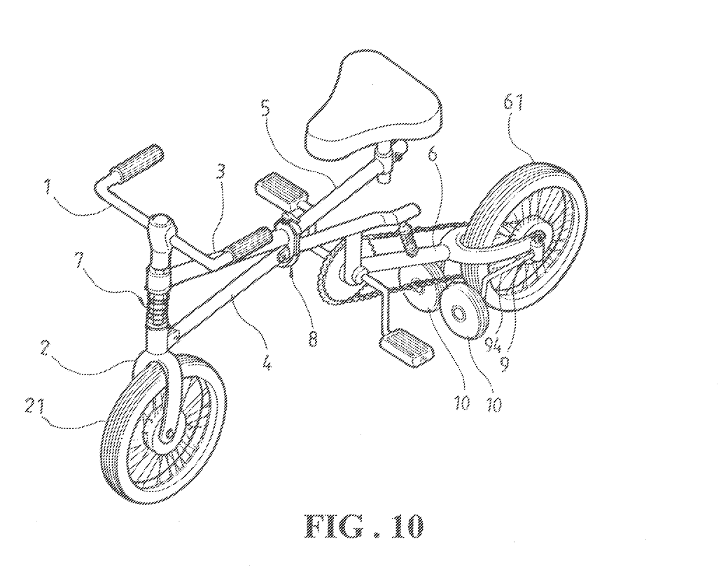

Referring to FIGS. 7 and 8, the adjusting device 9 of the present invention comprises a coupler bar 91 mounted to the rear fork 6 and having a cruciform cross section and further having a bottom portion having a circular cross section and forming an external threading 92. The coupler bar 91 extends through a circular barrel 93 that is mounted to an auxiliary wheel bracket 94 and that has an end face forming a cruciform opening 95 complementary to the coupler bar 91. The coupler bar 91, after extending through the circular barrel 93, is fit through a spring 96 and engages a nut 97 with the external threading 92. Thus, when the circular barrel 93 and the coupler bar 91 are moved with respect to each other to disengage the coupler bar 91 from the opening 95 of the barrel 93, the auxiliary wheel 10 that is supported by the bracket 94 mounted to the barrel 93 is allowed to freely rotate with respect to the coupler bar 91 so that the auxiliary wheel 10 can be switched to the operation condition where the auxiliary wheels 10 are substantially parallel to each other, as shown in FIG. 1, or the non-operation standby condition where the auxiliary wheels 10 are folded backward and positioned close to each other, as shown in FIG. 9, or the stowed condition where the auxiliary wheels 10 are folded forward and positioned close to the bicycle frame, as shown in FIG. 10, to reduce the amount of space that the bicycle occupies for easy storage and transportation. The coupler bar 91 can then be moved back into engagement with the opening 95 of the barrel 93 to secure the auxiliary wheel 10 at the selected position.

Although the present invention has been described with reference to the preferred embodiment thereof, it is apparent to those skilled in the art that a variety of modifications and changes may be made without departing from the scope of the present invention which is intended to be defined by the appended claims.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A foldable bicycle comprising:
a shock absorbing device comprising an upper tube in which an inner tube is fit to connect a handlebar, a first block fixed to a lower end of the inner tube, a mounting hole being defined in the first block to fit over and fix to a positioning bar, the positioning bar having a lower end forming a sliding section having a substantially triangular cross section; and a lower tube, which receives a tubular portion of a front fork therein, a second block being securely fixed to a top end of the tubular portion of the front fork, the second block and the top end of the tubular portion of the front fork both forming substantially triangular openings complementary in shape to the sliding section of the positioning bar to slidably receive the sliding section of the positioning bar therein, a spring being fit over the positioning bar and retained between the first and second blocks of the upper and lower tubes, a retention disk being is secured to a lower end of the positioning bar whereby shock absorption is realized by resiliency of the spring and sliding movement of the positioning bar;
a folding device comprising a case-like body having two portions that are switchable between open and closed conditions and that carry the connection bars and a seat bar and a rear fork respectively, one portion of the body forming a vertical tube and the other portion forming a complementary groove, a lock pin extending through a lower cap, the vertical tube, and an upper cap and pivoted to a holding lever, springs being arranged between the caps and the body respectively, whereby when the holding lever is depressed to securely hold the caps against the body, the portions of the body being maintained in the closed condition to expand the bicycle and when the holding lever is pulled upward, the caps are released by being biased by the springs, from the body and the portions of the body are allowed to open and thus allowing folding of the bicycle; and
an adjusting device arranged at one side of a rear wheel and comprising a coupler bar mounted to the rear fork and having a cruciform cross section, the coupler bar further comprising a bottom portion having a circular cross section and forming an external threading, the coupler bar extending through a barrel that is mounted to a bracket carrying an auxiliary wheel and having an end face forming a cruciform opening complementary to the coupler bar, whereby in the condition that the coupler bar, after extending through the barrel, is fit through a spring and engages a nut with the external threading, when the barrel and the coupler bar are moved with respect to each other to disengage the coupler bar from the opening of the barrel, the auxiliary wheel that is carried by the bracket is allowed to freely rotate with respect to the coupler bar to selectively position the auxiliary wheel in an operation condition, a non-operation standby condition, and a stowed condition.
